(19) United States
(12) Patent Application Publication
(10) Pub. No.: US 2008/0137373 A1
(43) Pub. Date: Jun. 12, 2008

(54) LIGHT GUIDE PLATE AND BACKLIGHT MODULE HAVING SAME

(75) Inventor: RUI-YONG LI, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/860,449

(22) Filed: Sep. 24, 2007

(30) Foreign Application Priority Data
Dec. 8, 2006 (CN) 200610157380.5

(51) Int. Cl. F21V 8/00

(52) U.S. Cl. 362/620

(57) ABSTRACT

A light guide plate (200) includes a block body (210) and a plurality of first prisms (220). The block body (210) has a light input surface (211), a light output surface (212) adjoining the light input surface (211) and a bottom surface (213) opposite to the light output surface (212). The light input surface (211) includes a plurality of flat portions (216) and at least one inwardly curved portion (215). The first prisms (220) are arranged on the inwardly curved portion (215) of the light input surface (211) and extend from the bottom surface (213) of the block body (210) to the light output surface (212) of the block body (210).

### BACKGROUND

1. Technical Field

The invention relates to backlight modules and light guide plates thereof, and particularly to a backlight module and a light guide plate thereof modulating light beams to have improved luminance and uniformity.

2. Description of Related Art

Currently, because a liquid crystal display (LCD) device has its characteristics, such as thin thickness, lightweight, long working lifetime and low power consumption, it is extensively used in a variety of electronic devices. The LCD device includes a LCD panel and a backlight module. The backlight module is generally disposed at a rear side of the LCD panel for providing the needed illumination.

Referring to FIG. 1, a conventional backlight module 10 includes a light source 11, a light guide plate 12, a reflection plate 13, a diffusion plate 14 and a prism plate 15. The light source 11 can employ a plurality of point light sources (e.g. light emitting diode, LED) or a linear light source (e.g. cold cathode fluorescent lamp, CCFL). The light guide plate 12 has a light input surface 121, a light output surface 122, and a bottom surface 123 opposite to the light output surface 122. The light source 11 is disposed adjacent to the light input surface 121 and emits light into the light guide plate 12, which allows the light to be redistributed and guides the light to exit from the light output surface 122. The reflection plate 13 is disposed adjacent to the bottom surface 123 of light guide plate 12. The reflection plate 13 is used to reflect the light emerging from the bottom surface 123 of light guide plate 12 so as to recapture the light into the light guide plate 12. The diffusion plate 14 and the prism plate 15 are disposed adjacent to the light output surface 122 of the light guide plate 12 to uniform the light emitting from the light guide plate 12.

Referring to FIG. 2, when several LEDs are employed by the LCD device as the light source 11, each of the LEDs emits the light at a certain range of angle and a scope of illumination of the light source 11 is the sum of the contributions of each LED's output light. Nevertheless, the illumination scope generally cannot cover the whole light guide plate 12. The hatched areas 16 show parts of the light guide plate 12 that are not illuminated. These parts are known as “dark zones”, which are formed between two LEDs. The existence of “dark zones” diminishes the performance of the backlight module 10.

What is needed, therefore, is a backlight module and a light guide plate thereof providing improved uniformity and luminance of the light.

### SUMMARY

A light guide plate is provided. In one embodiment, the light guide plate includes a block body and a plurality of first prisms. The block body has a light input surface, a light output surface adjoining the light input surface and a bottom surface opposite to the light output surface. The light input surface includes a plurality of flat portions and at least one inwardly curved portion. The first prisms are arranged on the inwardly curved portion of the light input surface and extend from the bottom surface of the block body to the light output surface of the block body.

A backlight module is provided. In one embodiment, the backlight module includes a light guide plate and at least one first light source. The light guide plate includes a block body and a plurality of first prisms. The block body has a light input surface, a light output surface adjoining the light input surface and a bottom surface opposite to the light output surface. The light input surface includes a plurality of flat portions and at least one inwardly curved portion. The first prisms are arranged on the inwardly curved portion of the light input surface and extend from the bottom surface of the block body to the light output surface of the block body. The first light source is disposed adjacent to the inwardly curved portion of the light input surface and has a light emitting surface whose configuration is corresponding to the configuration of the inwardly curved portion of the light input surface.

Advantages and novel features of the present backlight module and light guide plate thereof will become more apparent from the following detailed description of preferred embodiments when taken in conjunction with the accompanying drawings.

### BRIEF DESCRIPTION OF THE DRAWINGS

The components in the drawing are not necessarily drawn to scale, the emphasis instead being placed upon clearly illustrating the principles of the present invention.

FIG. 1 is a schematic view of a conventional backlight module;

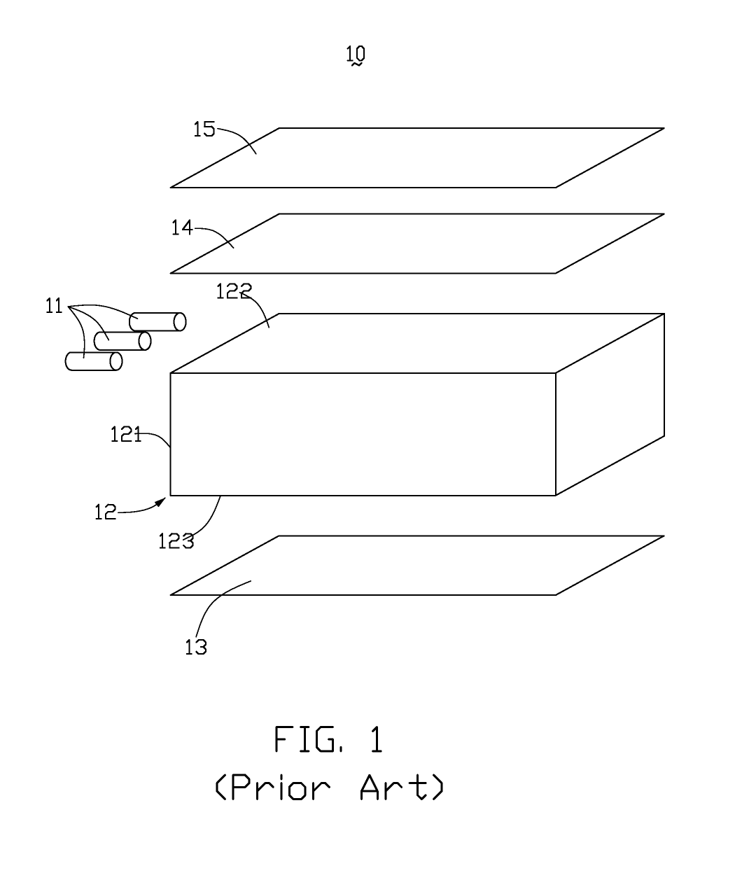

FIG. 2 is a schematic view of an illumination scope of the light source in the light guide plate of the conventional backlight module of FIG. 1;

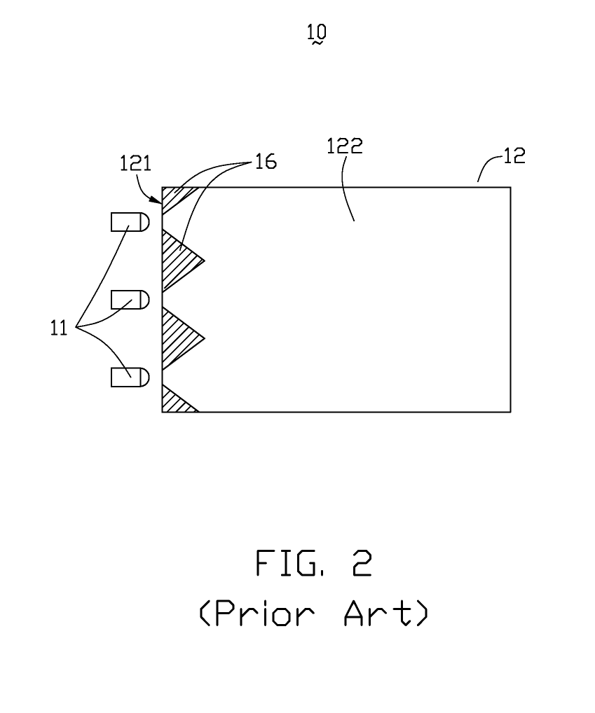

FIG. 3 is a schematic solid view of a light guide plate in accordance with a preferred embodiment of the present invention;

FIG. 4 is a schematic plan view of the light guide plate of FIG. 3;

FIG. 5 is a schematic solid view of another light guide plate in accordance with a preferred embodiment of the present invention;

FIG. 6 is a schematic plan view of the light guide plate of FIG. 5;

FIG. 7 is a schematic view of a backlight module in accordance with a preferred embodiment of the present invention; and

FIG. 8 is a schematic view of another backlight module in accordance with a preferred embodiment of the present invention.

Corresponding reference characters indicate corresponding parts. The exemplifications set out herein illustrate at least one preferred embodiment of the present backlight module and light guide plate thereof, in one form, and such exemplifications are not to be construed as limiting the scope of the invention in any manner.

### DETAILED DESCRIPTION OF THE EMBODIMENT

Reference will now be made to the drawings to describe embodiments of the present backlight module and light guide plate in detail.

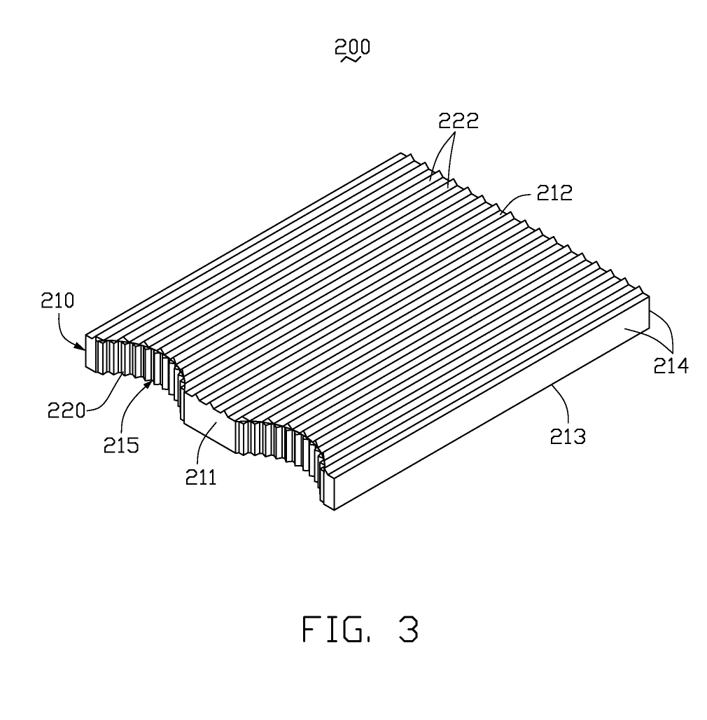

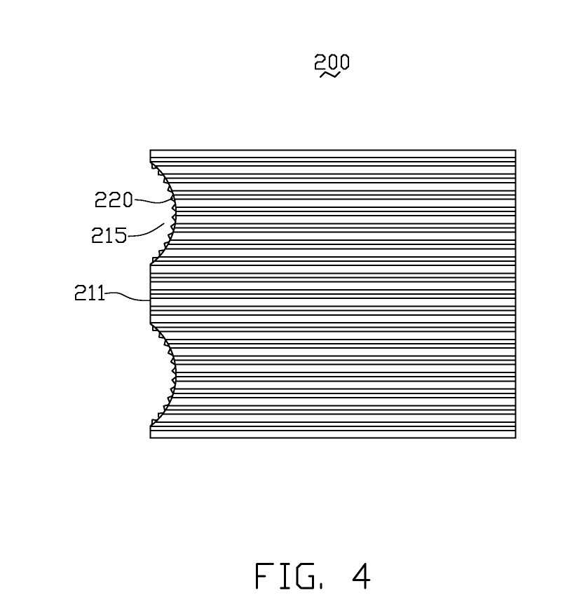

Referring to FIG. 3 and FIG. 4, a light guide plate 200 according to a preferred embodiment of the present invention is shown. The light guide plate 200 includes a block body 210 and a plurality of prisms 220. The block body 210 has a light input surface 211, a light output surface 212, a bottom surface 213 and a plurality of lateral surfaces 214. The light input surface 211 adjoins the light output surface 212. The bottom surface 213 is opposite to the light output surface 212. The lateral surfaces 214 connect the light input surface 211, the light output surface 212 and the bottom surface 213 to form the light guide plate 200 into a solid one. In the present embodiment, the light guide plate 200 is parallelepiped-shaped. The bottom surface 213 is opposite and parallel to the light output surface 212 while the light input surface 211 is perpendicularly to the light output surface 212 and the bottom surface 213.

The light input surface 211 of light guide plate 200 includes at least one inwardly curved portion 215 and a plurality of flat portions 216. The flat portions 216 and the inwardly curving portion 215 are acting as light receiving areas. In the present embodiment, the light input surface 211 has two inwardly curved portions 215 and three flat portions 216, as shown in FIG. 3. The inwardly curved portions 215 and the flat portions 216 are arranged in an alternate fashion. The inwardly curved portions 215, which interconnect the light output surface 212 and the bottom surface 213, are formed by curving inwardly with respect to the light input surface 211. In the present embodiment, the receiving areas 215 can be formed in U-shaped, V-shaped, arch-shaped or irregular-shaped.

Referring to FIG. 3 and FIG. 4, the prisms 220 are arranged on the inwardly curved portions 215 of the light input surface 211. The prisms 220 extend from the bottom surface 213 to the light output surface 212. That is, the prisms 220 span the inwardly curved portions 215 vertically and are perpendicularly to the light output surface 212. Additionally, the prisms 220 are arranged uniformly and parallel to each other. In the present embodiment, the prisms 220 are substantially identical in sizes and structures meeting the optical design in practice. As shown in FIG. 3, the prisms 220 can be triangular prisms disposed corresponding to the curvature of the inwardly curved portions 215. As shown in FIG. 3 and FIG. 4, the prisms 220 are arranged in shape of arch.

Referring to FIG. 3, the light guide plate 200 further includes a plurality of prisms 222 disposed on the light output surface 212 for allowing light to be exit from the light output surface 212 to have uniform distribution by emitting at a predetermined angle. In the present embodiment, the prisms 222 are disposed and spread on whole the light output surface 212.

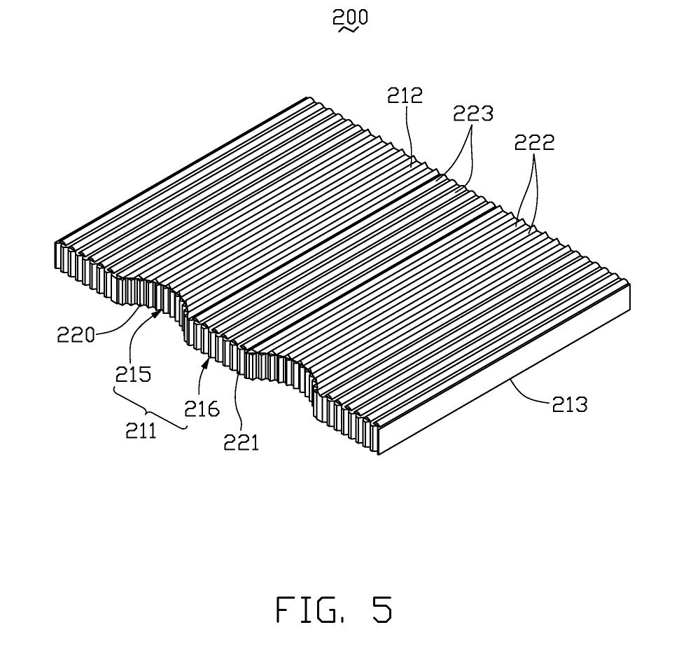

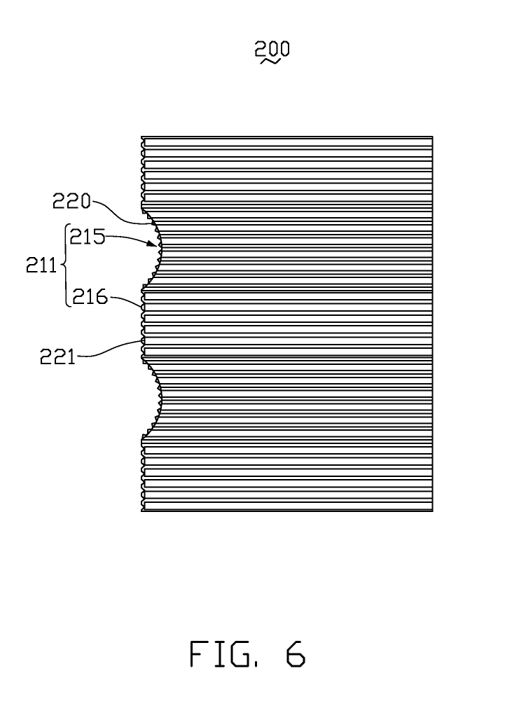

Referring to FIG. 5 and FIG. 6, another light guide plate 300 according to a preferred embodiment of the present invention is shown. The light guide plate 300 has the same elements as the light guide plate 200 mentioned above. The different is that the light guide plate 300 in the present embodiment further includes a plurality of prisms 321 disposed on the flat portions 316. The prisms 321 extend from the bottom surface 313 of the block body 310 to the light output surface 312 of the block body 310 and are perpendicularly to the light output surface 312. Additionally, the prisms 321 are arranged uniformly and parallel to each other on the flat portions 316. In the present embodiment, the prisms 321 on the flat portions 316 can be different from the prisms 320 on the inwardly curved portions 315.

As shown in FIG. 5, the prisms 322 disposed on the light output surface 312 are arranged spatially corresponding to the inwardly curved portion 315 of the light input surface 311. Alternatively, the prism 323 disposed on the light output surface 312 can be arranged spatially corresponding to the flat portions 316 of the light input surface 311. As shown in FIG. 5, the prisms 322 are arranged in parallel to each other corresponding to the inwardly curved portion 315 while the prisms 323 are arranged in parallel to each other corresponding to the flat portions 316. Furthermore, the prisms 322 disposed corresponding to the inwardly curved portions 315 can be different from the prisms 323 disposed corresponding to the flat portions 316. The sectional shape of prism 322, 323 can be triangular-shaped, trapezoid-shaped, sector-shaped or circular segment-shaped. For example, the prisms 322 are in shape of triangle while the prisms 323 are in shape of circular segment.

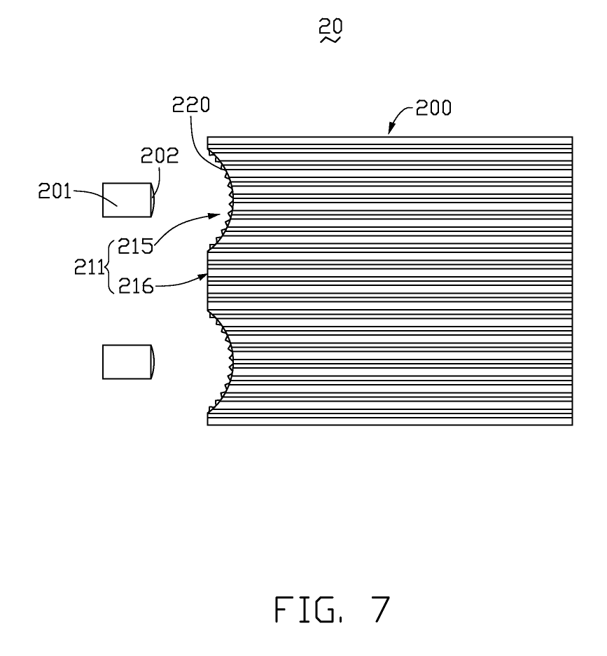

Referring to FIG. 7, a backlight module 20 according to a preferred embodiment of the present invention is shown. The backlight module 20 includes a light guide plate 200 and at least one light source 201. The backlight module 20 in the present embodiment has two light sources 201, as shown in FIG. 7.

In the present embodiment, due to the structure, function and characteristics of the light guide plate 200 are the same as the light guide plate 200 mentioned above, the detail description are omitted for concise.

The light sources 201 are disposed adjacent to the inwardly curved portions 215 of the light guide plate 200. Each of the light sources 201 has a light emitting surface 202, whose configuration is corresponding to that of the inwardly curved portion 215 of the light input surface. That is, the light emitting surfaces 202 of the light sources 201 face towards the inwardly curved portions 215 of the light input surface 211 and are configured to be convexes whose curvature match that of the inwardly curved portions 215.

As mentioned above, by way of allowing the curvature of light emitting surface 202 to match the curvature of the inwardly curved portions 215 where the prisms 220 are disposed, the divergent light emitted from the first light source 201 incident into the light input surface 211 at a predetermined angle and can reach every region in the light guide plate 200. In particular, the inwardly curved portions 215 are designed to disperse the incident light over angles in a range from 0 degrees to 140 degrees. More preferably, the light incident the inwardly curved portions 215 with the angle in the range from 0 degrees to 100 degrees. Furthermore, the prisms 222 on the light output surface 212 where the light to be emitted are designed to provide a viewing angle in a range from 0 degrees to 110 degrees. Preferably, the prisms 222 provide the viewing angles of light in the range from 0 to 100 degrees. As a result, the light is controlled and modulated to transmit in a specific way for achieving higher illumination and light uniformity. Thus, the scope of illumination can cover the whole light guide plate 200, so that the light guide plate 200 has no “dark zones”.

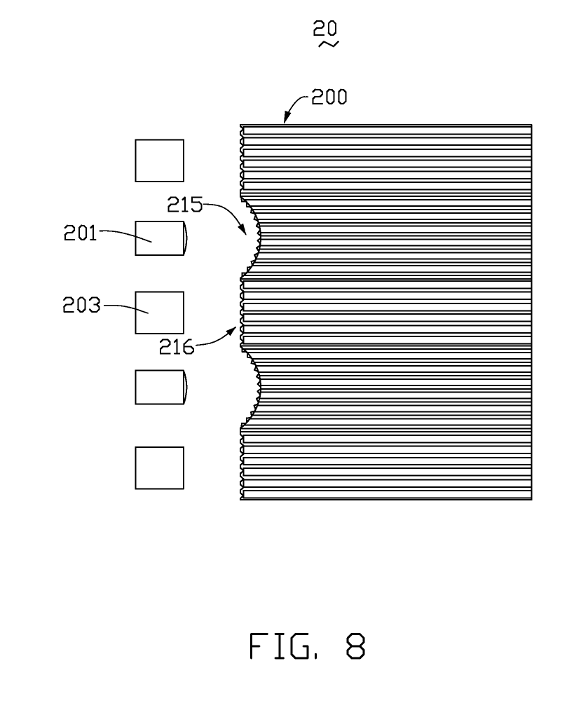

Referring to FIG. 8, another backlight module 30 according to a preferred embodiment of the present invention is shown. The backlight module 30 in the present embodiment includes a light guide plate 300, at least one first light source 301 and at least one second light source 303. The backlight module 30 in the present embodiment has two the first light sources 301 and three second light sources 303, as shown in FIG. 8.

In the present embodiment, due to the structure, function and characteristics of the light guide plate 300 are the same as the light guide plate 300 mentioned above, the detail description is omitted for concise.

The first light sources 301 are disposed adjacent to the inwardly curved portion 315 of the light guide plate 300. In the present embodiment, due to the characteristics of the first light sources 301 are the same as the light sources 201 mentioned above, the detail description is also omitted for concise.

The second light source 303 are disposed adjacent to the flat portion 316 of the light guide plate 300. In particular, each of the second light sources 303 has a plane light emitting surface 304 facing towards the flat portions 316. In such case, by way of forming the inwardly curved portions 315 and the flat portions 316 that have different curvatures from each other, the light can be modulated to obtain a variety of illuminated effects.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A light guide plate, comprising:
a block body having a light input surface, a light output surface adjoining the light input surface and a bottom surface opposite to the light output surface, the light input surface comprising a plurality of flat portions and at least one inwardly curved portion; and
a plurality of first prisms arranged on the inwardly curved portion of the light input surface and extending from the bottom surface of the block body to the light output surface of the block body.

2. The light guide plate as claimed in claim 1, wherein the inwardly curved portion of the light input surface interconnects the light output surface and the bottom surface, and the first prisms extend perpendicularly to the light output surface.

3. The light guide plate as claimed in claim 1, wherein the first prisms are parallel to each other and are disposed uniformly on the inwardly curved portion of the light input surface.

4. The light guide plate as claimed in claim 1, wherein the inwardly curved portion and the flat portions are arranged in an alternate fashion.

5. The light guide plate as claimed in claim 1, further comprising a plurality of second prisms arranged on the flat portion of the light input surface and extending from the bottom surface of the block body to the light output surface of the block body.

6. The light guide plate as claimed in claim 5, wherein the second prisms are parallel to each other and are disposed uniformly on the flat portion of the light input surface.

7. The light guide plate as claimed in claim 1, further comprising a plurality of third prisms disposed on the light output surface.

8. The light guide plate as claimed in claim 7, wherein the third prisms are disposed spatially corresponding to the inwardly curved portion of the light input surface.

9. The light guide plate as claimed in claim 7, wherein the third prisms are disposed spatially corresponding to the flat portions of the light input surface.

10. A backlight module, comprising:
a light guide plate comprising a block body and a plurality of first prisms, the body having a light input surface, a light output surface adjoining the light input surface and a bottom surface opposite to the light output surface, the light input surface comprising a plurality of flat portions and at least one inwardly curved portion, the first prisms arranged on the inwardly curved portion of the light input surface and extending from the bottom surface of the body to the light output surface of the body; and
at least one first light source disposed adjacent to the inwardly curved portion of the light input surface and having a light emitting surface whose configuration is corresponding to the configuration of the inwardly curved portion of the light input surface.

11. The backlight module as claimed in claim 10, wherein the inwardly curved portion of the light input surface interconnects the light output surface and the bottom surface, and the first prisms extend perpendicularly to the light output surface.

12. The backlight module as claimed in claim 10, wherein the first prisms are parallel to each other and are disposed uniformly on the inwardly curved portion of the light input surface.

13. The backlight module as claimed in claim 10, wherein the inwardly curved portion and the flat portions are arranged in an alternate fashion.

14. The backlight module as claimed in claim 10, further comprising a plurality of second prisms arranged on the flat portion of the light input surface and extending from the bottom surface of the block body to the light output surface of the block body.

15. The backlight module as claimed in claim 14, wherein the second prisms are parallel to each other and are disposed uniformly on the flat portion of the light input surface.

16. The backlight module as claimed in claim 10, further comprising a plurality of third prisms disposed on the light output surface.

17. The backlight module as claimed in claim 16, wherein the third prisms are disposed spatially corresponding to the inwardly curved portion of the light input surface.

18. The backlight module as claimed in claim 16, wherein the third prisms are disposed spatially corresponding to the flat portions of the light input surface.

19. The backlight module as claimed in claim 10, further comprising at least one second light source disposed adjacent to the flat portion of the light input surface.
